(19) United States
(12) Patent Application Publication
(10) Pub. No.: US 2010/0274636 A1
(43) Pub. Date: Oct. 28, 2010

(54) SYSTEMS AND METHODS FOR PERSONALIZED EMPLOYEE ENGAGEMENT

(75) Inventor: Kevin A. Sheridan, Wilmette, IL (US)

Correspondence Address: SNELL & WILMER L.L.P. (Main), 400 EAST VAN BUREN, ONE ARIZONA CENTER, PHOENIX, AZ, 85004-2202, US

(73) Assignee: HR SOLUTIONS, INC., Chicago, IL (US)

(21) Appl. No.: 12/834,148

(22) Filed: Jul. 12, 2010

Related U.S. Application Data
(63) Continuation-in-part of application No. 12/428,198, filed on Apr. 22, 2009.
(60) Provisional application No. 61/082,902, filed on Jul. 23, 2008.

(51) Int. Cl. G06Q 10/00

(52) U.S. Cl. 705/10

(57) ABSTRACT

Systems and methods for human resource activities are disclosed. The system allows a user to specify an organizational structure of an entity, design survey respondents, customize items, response logic and reporting dimensions. The system also allows a user to undergo a personalized employee engagement. The system analyzes results, provides recommendations and allows users to formulate action plans based upon the results.

### CROSS REFERENCE TO RELATED APPLICATIONS

This application is a continuation-in-part of U.S. patent application Ser. No. 12/428,198 entitled “Systems and Methods for Managing Human Resource Activities” filed on Apr. 22, 2009. The '198 application claims the benefit of, and priority to, U.S. Provisional Patent Application Ser. No. 61/082,902 entitled “System and Method for Managing Human Resource Activities” filed on Jul. 23, 2008. Both the '198 application and the '902 application are hereby incorporated by reference.

### FIELD OF INVENTION

The present invention relates to a system for managing human resource activities, and more specifically, to an improved software system for designing, administering, and enabling personalized employee engagement.

### BACKGROUND OF THE INVENTION

Employee engagement has become a sort of “holy grail” of the business environment. The idea of employee engagement borrows from the concept that a company wants to create a mutually-beneficial long-term relationship with employees and, by extension, customers, such that commitment, loyalty, and profitability can soar. As is often the case, an employer cannot manage it if the employer does not measure it. Because of its impact on organizational reputation, employee turnover, and financial performance beginning in the mid-1990's, companies worldwide have tried to optimize client engagement by describing it, measuring it, and taking actions to increase it. Typically the process of optimizing client engagement has been manual. Even if a particular aspect of the effort to optimize client engagement is automated, typical systems used to support these efforts do not contemplate the overall process and thus lack the seamless integration of functionality and data that is needed. For instance, a system may collect survey data but lack the ability to effectively analyze data and leverage the data by providing a means to devise and implement corrective action plans

Thus, prior systems typically fail to fully automate the employee engagement measurement process (which often involves employee surveys) and fail to provide features for documenting and tracking follow-up activities associated with employee engagement efforts. Therefore, a long felt need exists for fully integrated and comprehensive automation that enables an organization to plan, execute, analyze and follow-up on employee engagement measurement and process improvement efforts.

### SUMMARY OF THE INVENTION

Systems and methods to design, configure, administer and analyze a survey are disclosed. In one embodiment, the system receives organizational data from an organization by, for example, receiving an uploaded organizational chart or other hierarchical data (e.g., reporting structure, organization structure, locations/entities, titles, demographics, etc.). The system also receives survey configuration data including an identification of requested survey respondents. The survey respondents are related to the organizational data in order to, for example, determine the level of the survey respondents and match such respondents with the appropriate survey items (e.g., questions). The system identifies a plurality of possible survey items and creates a survey by transforming the survey configuration data and accumulating potential survey items. The transformation results in a survey that includes survey items, survey respondents and a survey format.

In an embodiment, the system is configured to receive survey responses and analyze the responses based upon a variety of factors such as the organizational data, predefined rules (e.g., demographic definitions, custom calculations for a specific dimension, etc.), historical data, etc. A user may configure an action plan using a system to address survey results and track progress on the action plan using the system.

### BRIEF DESCRIPTION OF THE DRAWINGS

The present invention will hereinafter be described in conjunction with the appended drawing figures, wherein like numerals denote like elements, and wherein;

FIG. 1 is a block diagram depicting various system components for a virtual school system, in accordance with one embodiment of the present invention; and

FIG. 2 is a flow chart depicting a representative process for designing, creating and implementing a survey, in accordance with one embodiment of the present invention.

### DETAILED DESCRIPTION

The detailed description of exemplary embodiments of the invention herein makes reference to the accompanying drawings, which show embodiments by way of illustration and best mode. While these embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system. Additionally, any reference to singular may include more than one, and any reference to plural may include one item.

The benefits provided by this invention include, for example, increased employee satisfaction, employee engagement, increased organizational efficiency and cost savings. The solutions and functionality may provide quick, accurate, and actionable survey results. Organizations may make important decisions based upon the data and analysis provide which will help in reengineering broken processes, addressing workplace inefficiencies, identifying dissatisfaction and focusing on underperforming work teams. Action plan features assist in the design and implementation of programs to address areas identified for improvement.

In one embodiment, the system includes a user interface (UI), a software module, logic engines, numerous databases and computer networks. While the system may contemplate upgrades or reconfigurations of existing processing systems, changes to existing databases and business information system tools are not necessarily required by the system.

Briefly, while the description references specific technologies, system architectures and data management techniques, practitioners will appreciate that this description is but one embodiment and that other devices and/or methods may be implemented without departing from the scope of the invention. Similarly, while the description references a user interfacing with the system via a personal computer user interface, practitioners will appreciate that other interfaces may include mobile devices, kiosks and handheld devices such as personal digital assistants.

“Entity” may include any individual, consumer, customer, group, business, organization, government entity, software, hardware, and/or any other entity. “Employee” may include any individual, group, software and/or hardware associated with an entity. A “user” may include any individual, employee, and/or entity that interacts with a system or participates in a process.

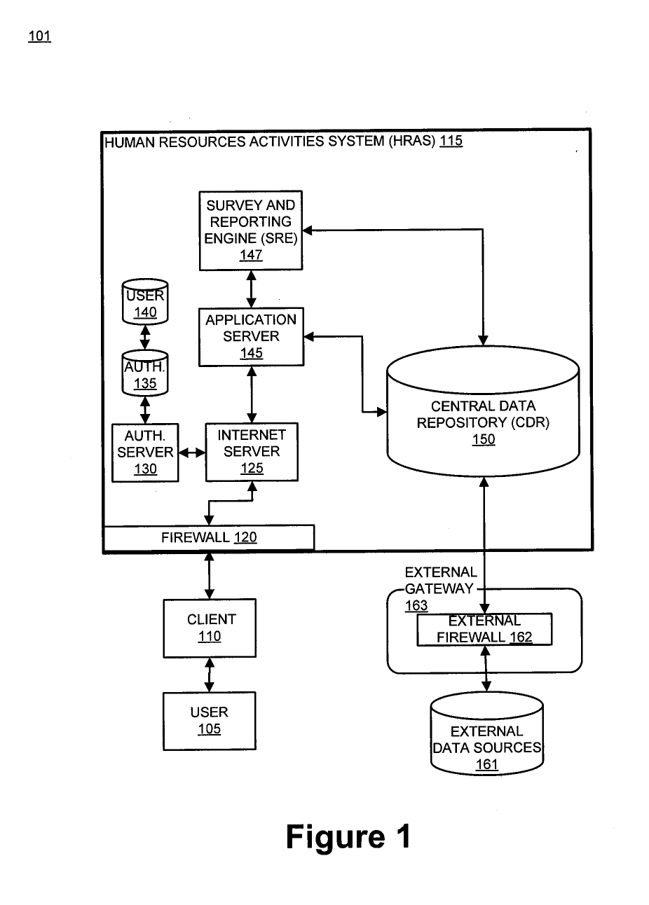

With reference to FIG. 1, user 105 may perform tasks such as requesting, retrieving, receiving, updating, analyzing, entering and/or modifying data. User 105 may interface with Internet server 125 via any communication protocol, device or method discussed herein, known in the art, or later developed. User 105 may be, for example, a system administrator, a survey respondent, a manager, an executive or a management consultant. Users may be assigned to roles that are used to determine user permissions or default user interfaces and reports.

In one embodiment, with reference to FIG. 1, system 101 includes a user 105 interfacing with Human Resource Activities System (HRAS) 115 by way of client 110. Client 110 comprises any hardware and/or software suitably configured to facilitate requesting, retrieving, updating, analyzing, entering and/or modifying data. The data may include survey data, entity organizational data, reporting hierarchies, verification data, authentication data, result data, demographic data, testing data, transaction data, performance and reporting data or any information discussed herein. Client 110 includes any device (e.g., personal computer), which communicates (in any manner discussed herein) with the HRAS 115 via any network discussed herein. Browser applications comprise Internet browsing software installed within a computing unit or system to conduct online communications and transactions. These computing units or systems may take the form of personal computers, mobile phones, personal digital assistants, mobile email devices, laptops, notebooks, hand held computers, portable computers, kiosks, and/or the like. Practitioners will appreciate that the client 110 may or may not be in direct contact with the HRAS 115. For example, the client 110 may access the services of the HRAS 115 through another server, which may have a direct or indirect connection to Internet server 125.

User 105 may communicate with the HRAS 115 through a firewall 120 to help ensure the integrity of the HRAS 115 components. Internet server 125 may include any hardware and/or software suitably configured to facilitate communications between the client 110 and one or more HRAS 115 components.

Authentication server 130 may include any hardware and/or software suitably configured to receive authentication credentials, encrypt and decrypt credentials, authenticate credentials, and/or grant access rights according to pre-defined privileges attached to the credentials. Authentication server 130 may grant varying degrees of application and data level access to users based on information stored within authentication database 135 and user database 140. Application server 145 may include any hardware and/or software suitably configured to serve applications and data to a connected client 110.

According to one embodiment, HRAS 115 is used to manage and completely or partially integrate an online survey system, including survey design, distribution, response collection, result analysis and reporting. HRAS 115 is a fully integrated system comprised of various subsystems, modules and databases. With reference again to FIG. 1, HRAS 115 combines and allows communication between Human Resources Management Module (“HRMM”), Survey and Reporting Engine (“SRE”) 147, various portals and UIs (not shown in FIG. 1), central data repository (“CDR”) 150 and external data sources 161. In one embodiment, UIs are accessed via a web portal.

SRE 147 is a software module configured to enable online functions such as receiving query requests, configuring responses, dynamically configuring user interfaces, requesting data, receiving data, prompting user 105 with security challenges, verifying user responses, authenticating the user, initiating HRAS 115 processes, initiating other software modules, encrypting and decrypting. Additionally, SRE 147 may include any hardware and/or software suitably configured to receive requests from client 110 via Internet server 125 and the application server 145. SRE 147 is further configured to process requests, execute transactions, construct database queries, and/or execute queries against databases, system 101 (e.g., CDR 150), external data sources 161 and temporary databases.

SRE 147 is configured to exchange data with other systems and application modules such as CDR 147 and application server 145. In one embodiment, SRE 147 may be configured to interact with other system 101 components to perform complex calculations, retrieve additional data, format data into reports, create XML representations of data, construct markup language documents, construct, define or control UIs, and/or the like. Moreover, SRE 147 may reside as a standalone system or may be incorporated with the application server 145 or any other HRAS 115 component as program code. As one of ordinary skill in the art will appreciate, SRE 147 may be logically or physically divided into various subcomponents such as a workflow engine configured to evaluate predefined rules and to automate processes associated with an entity or survey implemented in HRAS 115. In one embodiment, SRE 147 is configured to automate, track, route, status and manage tasks, messages and events associated with other HRAS 115 subsystems and integrated processes.

In addition to the components described above, system 101, HRAS 115 and CDR 150 may further include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases.

As will be appreciated by one of ordinary skill in the art, one or more system 101 components may be embodied as a customization of an existing system, an add-on product, upgraded software, a stand-alone system (e.g., kiosk), a distributed system, a method, a data processing system, a device for data processing, and/or a computer program product. Accordingly, individual system 101 components may take the form of an entirely software embodiment, an entirely hardware embodiment, or an embodiment combining aspects of both software and hardware. Furthermore, individual system 101 components may take the form of a computer program product on a tangible computer-readable storage medium having computer-readable program code means embodied in the storage medium. Any suitable computer-readable storage medium may be utilized, including hard disks, CD-ROM, optical storage devices, magnetic storage devices, and/or the like.

Client 110 may include an operating system (e.g., Windows XP, Windows NT, 95/98/2000, XP, Vista, OS2, UNIX, Linux, Solaris, MacOS, Windows Mobile OS, Windows CE, Palm OS, Symbian OS, Blackberry OS, J2ME, etc.) as well as various conventional support software and drivers typically associated with mobile devices and/or computers. Client 110 may be in any environment with access to any network, including both wireless and wired network connections. In an embodiment, access is through a network or the Internet through a commercially available web-browser software package. Client 110 and HRAS 115 components may be independently, separately or collectively suitably coupled to the network via data links which includes, for example, a connection to an Internet Service Provider (ISP) over the local loop as is typically used in connection with standard wireless communications networks and/or methods, modem communication, cable modem, Dish networks, ISDN, Digital Subscriber Line (DSL), see, e.g., Gilbert Held, Understanding Data Communications (1996). In an embodiment, any portion of client 110 is partially or fully connected to a network using a wired (“hard wire”) connection. As those skilled in the art will appreciate, client 110 and/or any of the system components may include wired and/or wireless portions.

Firewall 120, as used herein, may comprise any hardware and/or software suitably configured to protect HRAS 115 components from users of other networks. Firewall 120 may reside in varying configurations including stateful inspection, proxy based and packet filtering, among others. Firewall 120 may be integrated as software within Internet server 125, any other system 101 component, or may reside within another computing device or may take the form of a standalone hardware component.

Internet server 125 may be configured to transmit data to client 110 within markup language documents. “Data” may include encompassing information such as commands, transaction requests, queries, files, data for storage, and/or the like in digital or any other form. Internet server 125 may operate as a single entity in a single geographic location or as separate computing components located together or in separate geographic locations. Further, Internet server 125 may provide a suitable web site or other Internet-based graphical user interface, which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, InterBase, etc., may be used to provide an Active Data Object (ADO) compliant database management system.

Like Internet server 125, application server 145 may communicate with any number of other servers, databases and/or components through any means known in the art. Further, application server 145 may serve as a conduit between client 110 and the various systems and components of HRAS 115. Internet server 125 may interface with application server 145 through any means known in the art including a LAN/WAN, for example. Application server 145 may further invoke software modules such as the SRE 147 in response to user 105 requests.

Any of the communications, inputs, storage, databases or displays discussed herein may be facilitated through a web site having web pages. The term “web page” as it is used herein is not meant to limit the type of documents and applications that may be used to interact with the user. For example, a typical web site may include, in addition to standard HTML documents, various forms, Java applets, JavaScript, active server pages (ASP), common gateway interface scripts (CGI), Flash files or modules, FLEX, ActionScript, extensible markup language (XML), dynamic HTML, cascading style sheets (CSS), helper applications, plug-ins, and/or the like. A server may include a web service that receives a request from a web server, the request including a URL (e.g., http://yahoo.com/) and an interne protocol (“IP”) address. The web server retrieves the appropriate web pages and sends the data or applications for the web pages to the IP address. Web services are applications that are capable of interacting with other applications over a communications means, such as the Internet. Web services are typically based on standards or protocols such as XML, SOAP, WSDL and UDDI. Web services methods are well known in the art, and are covered in many standard texts. See, e.g., Alex Nghiem, IT Web Services: A Roadmap for the Enterprise (2003).

FIG. 1 depicts databases that are included in an embodiment. An exemplary list of various databases used herein includes: an authentication database 135, a user database 140, CDR 150, external data sources 161 and/or other databases that aid in the functioning of the system. As practitioners will appreciate, while depicted as separate and/or independent entities for the purposes of illustration, databases residing within system 101 may represent multiple hardware, software, database, data structure and networking components. Furthermore, embodiments are not limited to the exemplary databases described herein, nor do embodiments necessarily utilize each of the disclosed exemplary databases.

Authentication database 135 may store information used in the authentication process such as, for example, user identifiers, passwords, access privileges, user preferences, user statistics, and the like. User database 140 maintains user information and credentials for HRAS 115 users (e.g., user 105).

CDR 150 is a data repository that is configured to store a wide variety of comprehensive data for HRAS 115. While depicted as a single logical entity in FIG. 1, those of skill in the art will appreciate that CDR 150 may, in some embodiments, consist of multiple physical and/or logical data sources. In one embodiment, CDR 150 stores organizational data, hierarchical data demographic data, historical data, normative data, employee records, response data, survey data, reporting format data, UI configuration data, reporting data, audit records, predefined rules, process definitions (e.g., survey results approval process), financial data, schedules and the like.

External data source 161 represents databases and other data sources that are accessible by CDR 150 and other HRAS 115 components. In one embodiment, external data source 161 data may be provided by a third party data provider. For example, in one embodiment, HRAS 115 is configured to analyze survey data based upon normative results of like entities (e.g. survey results of a company in the same industry).

System 101 may be interconnected to external data source 161 (for example, to obtain data from a government entity, another school system, or a vendor) via a second network, referred to as the external gateway 163. The external gateway 163 may include any hardware and/or software suitably configured to facilitate communications and/or process transactions between system 101 and the external data source 161. Interconnection gateways are commercially available and known in the art. External gateway 163 may be implemented through commercially available hardware and/or software, through custom hardware and/or software components, or through a combination thereof. External gateway 163 may reside in a variety of configurations and may exist as a standalone system or may be a software component residing, for example, inside HRAS 115, CDR 150, the external data source 161 or any other known configuration. External gateway 163 may be configured to deliver data directly to system 101 components (such as SRE 147) and to interact with other systems and components such as CDR 150 databases. In one embodiment, the external gateway 163 may comprise web services that are invoked to exchange data between the various disclosed systems. The external gateway 163 represents existing proprietary networks that presently accommodate data exchange for data such as financial transactions, customer demographics, billing transactions and the like. The external gateway 163 is a closed network that is assumed to be secure from eavesdroppers.

Any databases discussed herein may include relational, hierarchical, graphical, or object-oriented structure and/or any other database configurations. Common database products that may be used to implement the databases include DB2 by IBM (Armonk, N.Y.), various database products available from Oracle Corporation (Redwood Shores, Calif.), Microsoft Access or Microsoft SQL Server by Microsoft Corporation (Redmond, Wash.), MySQL by MySQL AB (Uppsala, Sweden), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one aspect of the invention, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

One skilled in the art will also appreciate that, for security reasons, any databases, systems, devices, servers or other components of system 101 may consist of any combination thereof at a single location or at multiple locations, wherein each database or system includes any of various suitable security features, such as firewalls, access codes, encryption, decryption, compression, decompression, and/or the like.

The systems and methods may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Java, JavaScript, Flash, ActionScript, FLEX, VBScript, Macromedia Cold Fusion, COBOL, Microsoft Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall.

These software elements may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that may direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, may be implemented by either special purpose hardware-based computer systems which perform the specified functions or steps, or suitable combinations of special purpose hardware and computer instructions. Further, illustrations of the process flows and the descriptions thereof may make reference to user windows, web pages, web sites, web forms, prompts, etc. Practitioners will appreciate that the illustrated steps described herein may comprise in any number of configurations including the use of windows, web pages, web forms, popup windows, prompts and/or the like. It should be further appreciated that the multiple steps as illustrated and described may be combined into single web pages and/or windows but have been expanded for the sake of simplicity. In other cases, steps illustrated and described as single process steps may be separated into multiple web pages and/or windows but have been combined for simplicity.

Practitioners will appreciate that there are a number of methods for displaying data within a browser-based document. Data may be represented as standard text or within a fixed list, scrollable list, drop-down list, editable text field, fixed text field, pop-up window, and/or the like. Likewise, there are a number of methods available for modifying data in a web page such as, for example, free text entry using a keyboard, selection of menu items, check boxes, option boxes, and/or the like.

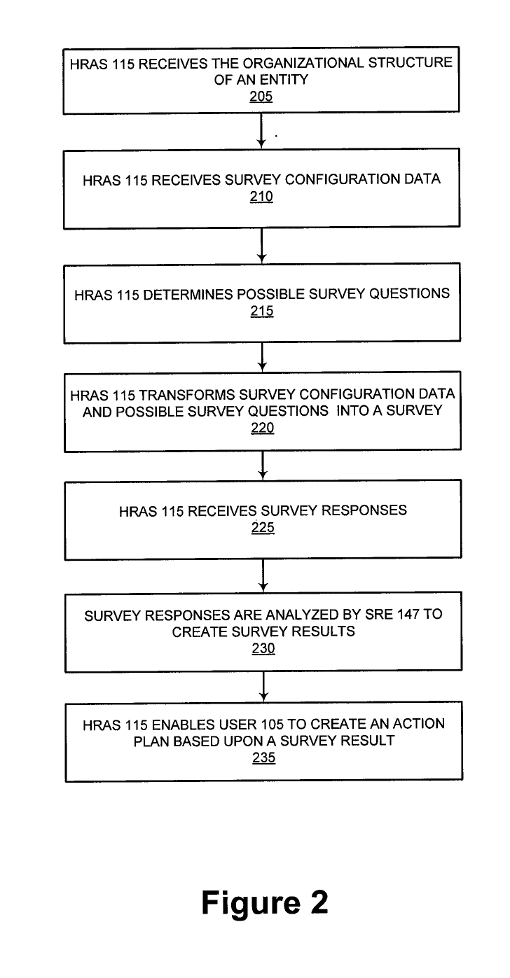

Referring now to the figures, the block system diagrams and process flow diagrams represent mere embodiments and are not intended to limit the scope of the invention as described herein. For example, the steps recited in FIG. 2 may be executed in any order and are not limited to the order presented. It will be appreciated that the following description makes appropriate references not only to the steps depicted in FIG. 2, but also to the various system components as described above with reference to FIG. 1.

With reference to FIG. 1, in one embodiment, when user 105 logs onto an application (e.g., HRMM 146), Internet server 125 may invoke an application server 145. Application server 145 invokes logic in the HRMM 146 and/or SRE 147 by passing parameters relating to the user's 105 requests for data. In one embodiment, HRAS 115 manages requests for data from SRE 147 and communicates with system 101 components. Transmissions between user 105 and Internet server 125 may pass through a firewall 120 to help ensure the integrity of HRAS 115 components. Practitioners will appreciate that the invention may incorporate any number of security schemes or none at all. In one embodiment, Internet server 125 receives page requests from client 110 and interacts with various other system 101 components to perform tasks related to requests from client 110.

Internet server 125 may invoke an authentication server 130 to verify the identity of user 105 and assign roles, access rights and/or permissions to user 105. In order to control access to the application server 145 or any other component of HRAS 115, Internet server 125 may invoke an authentication server 130 in response to user 105 submissions of authentication credentials received at Internet server 125. A request to access system 101 is received from Internet server 125 and Internet server 125 determines if authentication is required and transmits a prompt to client 110. User 105 enters authentication data at client 110, which transmits the authentication data to Internet server 125. Internet server 125 passes the authentication data to authentication server which queries the user database 140 for corresponding credentials. When user 105 is authenticated, user 105 may access various applications and their corresponding data sources.

In one embodiment, HRAS 115 enables an organization to fully automate a data collection effort (e.g. a survey) including identifying respondents, survey items, and format and analyzing and acting upon survey results. For example, HRAS 115 allows an entity to generate customized reports incorporating normative and historical data; determine key trends and relationships within workgroups; assist managers in creating effective action plans based on results (e.g. to address opportunities for improvement identified by the results); benchmark a variety of factors utilizing qualitative, quantitative, and normative data; and monitor progress of implemented action plans.

Referring now to FIG. 2, a representative process for designing, administering and analyzing a survey is shown. HRAS 115 receives the organizational structure of an entity (e.g. a company) (Step 205). HRAS 115 allows for any type of structure such as a functional hierarchy, management hierarchy, and/or a reporting hierarchy. In one embodiment, the organizational structure determined by the system inferentially from employee demographic data (e.g. salary data is used to determine role in the company). In one embodiment, user 105 (e.g. a human resources manager at a company) enters the organizational structure via client 110 using a web form provided by HRAS 115. In one embodiment, HRAS 115 determines the organizational structure based upon a file that is uploaded onto the system and based upon predefined file formats or predefined rules stored in CDR 150. In an embodiment, the organization structure is provided by linking to an external database such as external data source 161.

As previously discussed, CDR 150 is configured to store predefined rules. As one of skill in the art will appreciate, predefined rules may include rules based upon business rules, external data, historical data, trends, statistical analysis or other calculation, demographic data, organizational data, and the like.

Referring again to FIG. 2, HRAS 115 receives survey configuration data (Step 210). In one embodiment, survey configuration data identifies a list of respondents that may be candidates for receiving a survey. In various embodiments, the survey configuration data may also include survey items, ranges for responses to the survey items, a survey format, survey start and end dates, a survey name, action plan parameters, optional respondent, required respondents and custom dimensions. In one embodiment, the survey format is determined from a preexisting template (e.g. a template stored in CDR 150). Dimensions are categories or factors that may be associated with, for example, an item, a response, an item/response pair, a group of items, a user role, an organization and/or a functional area. For example, a “job satisfaction” dimension may be associated with a series of items and the results of those items used in the analysis of survey results to draw inferences, form conclusions or formulate action plans regarding job satisfaction of the respondents.

HRAS 115 determines the possible survey items (Step 215). As discussed above, in one embodiment, possible survey items may be provided in the survey configuration data. In an embodiment, possible survey items may be determined from CDR 150, which stores a list of historical survey items, and/or a third party data source.

HRAS 115 transforms the survey configuration data and the possible survey items (identified in step 215) into a survey (Step 220). The survey is comprised of final survey items, final survey respondents and a survey format. In an embodiment, HRAS 115 determines the final survey items based upon a variety of factors. For example, survey item types and number of items. The survey items or final item prompts may be determined based upon the type of organization, the industry or service sector, the number of respondents, the job functions of the respondents, historical responses, demographic information of respondents (e.g. number of years of service with the company), etc. In one embodiment, a custom set of survey items are determined for each survey respondent based upon, for example, responses or non-responses to previous surveys. For example, if a person tends to answer certain items more positively, then the custom survey items may take such “overly” positive responses in account when creating new items and potential answer choices. In an embodiment, creating the survey includes associating dimensions with the final survey items.

In creating the survey, HRAS 115 also invokes logic in SRE 147 to determine the final list of survey respondents (e.g. those users that will be prompted to respond to the survey). In one embodiment, SRE 147 checks CDR 150 to determine the last time a requested respondent completed a survey in order to decide whether the requested respondent will be include in the list of final respondents. In an embodiment, SRE 147 checks predetermined rules to ensure that a correct number of respondents (or respondents of a particular type) is included in the survey. For example, if the requested respondents disproportionally represent one functional group, while under representing another, SRE 147 may add or omit respondents when determining the final respondents.

In an embodiment, the format of the survey is provided in the survey configuration data. The format of the survey may include the aesthetic and functional factors. For example, the survey format may dictate color scheme and graphics, specify custom messages or instructions to be displayed, how long to allow a respondent to consider an item, whether to allow a respondent to skip items, etc. In an embodiment, the survey format indicates that items be presented in a foreign language and SRE 147 invokes translation logic to format the final survey items. In one embodiment, the format of the survey also includes the mode of delivering the survey. The survey is delivered to a user's 105 client 110 using a web portal or a web application. In an embodiment, modes for delivering the survey may also include an automated voice response system delivered to a user via a phone device or a paper form (e.g. a scantron form).

HRAS 115 receives survey responses (Step 225). In one embodiment, SRE 147 applies branching logic to select final survey items interactively (e.g. in real-time or near real-time) based upon a previous response provided by a respondent. In an embodiment, associating branching logic with survey items is part of the creating the survey. For example, SRE 147 analyzes one or more factors, such as the final survey items and industry guidelines, to determine item and response pairs that indicate that a second item be asked.

Survey responses are analyzed by SRE 147 to create survey results (Step 230). SRE 147 uses various parameters, calculations and rules to analyze the survey responses. In one embodiment, predetermined rules may be used to determine survey results. For example, the survey configuration data may specify that items whose responses have a statistical variance greater than a certain threshold should be ignored. In an embodiment, the analysis of survey responses may be based upon historical results (e.g. to calculate a trend) or the responses may be compared to industry benchmarks to determine variance from an accepted norm. In various embodiments, result analysis includes measurement on various response scales (e.g., Likert Scale, Importance Scale), comparison calculations, normative data analysis, correlation calculations, and favorable and unfavorable analysis.

HRAS 115 enables user 105 to create an action plan based upon a survey result (e.g., a survey item, a dimension, personnel associated with a result or dimension, etc.) (Step 235). In one embodiment, HRAS 115 prompts user 105 to create an action plan in response to a result. For example, HRAS 115 emails a manager with notification that the survey results indicate that the training dimension may need attention, corrective action or the like. User 105 (e.g., a manager) logs into HRAS 115, views survey results, reports and analysis, and creates an action plan to address the training shortcoming and associates the action plan with the survey dimension. In one embodiment SRE 147, using data from CDR 150, pre-populates a suggested action plan for a manager to address opportunities for improvement (e.g., by comparing the manager's results to peers' results). This feature allows selected managers to be presented with their results (e.g., lowest scores from their reports) with the ability to create an ‘Action Plan’ using self generated plans, or from a list of approved recommendations. In an embodiment, a user 105 is able to view recommendations from other users and/or a library of best practices and select proven or “best practice” recommendations to include in the action plan. HRAS 115 also enables mentor based action planning. An employee that may receive deficient, underperforming or otherwise undesirable rating for a survey dimension (or an individual survey item), is presented with a list of individuals that scored better on the same or similar dimension. The employee is able to chose a mentor from the list and create action plans to track and coordinate receiving mentoring guidance from the chosen mentor.

In one embodiment, an action plan and results associated with the action plan (e.g. completed tasks) are associated with the survey result and/or the survey item (or group of items) associated with the survey result. In an embodiment, HRAS 115 enables a user 105 to assign a milestone date (e.g. due date) or a reminder date with the action plan. In an embodiment, the action plan is comprised of multiple steps or tasks each of which are associated with their own set of dates. In an embodiment, SRE 147 is configured with workflow logic to assess action plan tasks, report status, prompt users with tasks based upon an action plan task being completed, etc. The action plan feature also includes tracking of action plan completion and the ability of user 105 to mark action items or action plans as complete. The action plan feature also provides an interface and proactive notifications that display action plan information (e.g., indication of overdue plans) to user 105. In one embodiment, an action plan interface includes three tabs—“Opportunities,” “Additional items” and “Custom Plans”. In one embodiment the tabs provide action plans that are pre-populated with appropriate data. For example, the “Opportunities” tab may pre-populate action items with a number of items the manager scored low on compared to the rest of organization and a number of other items that were most unfavorable (e.g., tab pre-populated with three low items and three other most unfavorable items). Additional items show all items that are not opportunities. Custom plans allow user 105 to create plans irrespective of the items. In one embodiment, the action plan feature allows for future surveys to assess the effectiveness of the action plan on addressing an area of improvement. For example, management and/or human resources personnel may view a completed action plan, assess it and assign a grade (or provide other feedback) to the person(s) that is responsible for executing the action plan. Also, HRAS 115 enables viewing a completed action plan, assessing it and assigning a grade to the action plan.

In one embodiment, HRAS 115 enables ranking action plan recommendations based upon their proven impact and/or effectiveness. The rank ordering may be performed automatically (e.g., by SRE 147) or by user 105. This feature provides the ability to track the outcomes of recommendations based on a manager's (or any personnel, program, organization or other entity) next survey results using Artificial Intelligence (AI) methods. For example, a manager whose score on a particular item or dimension improved the most using a particular recommendation cause that recommendation to be ranked higher in future action planning (i.e., step 235).

HRAS 115 also includes an extensive reporting system. HRAS 115 reporting capabilities include predefined reports and customizable reports. Reports are configurable and customizable to user and/or organizational specifications. In one embodiment a personalized employee engagement report provides user 105 some ownership in the employee engagement process. The client employee is asked if he wants to receive a personalized engagement report. If the client employee accepts the request and provides their email, the client employee is given a summary of their engagement along with ideas about how they can improve or maintain their engagement. The reports are viewable online (e.g. via a web portal), or the reports may be printed. For example, reports used to present survey results and related information include:
Dimension Profile Report
Item profile Report
Favorable Item Report
Unfavorable Item Report
Correlation Report
Survey Analysis Report
Union Vulnerability report
Matrix Report
Data Result Sheets by Dimension
Data Result Sheets by Item
Parameter by Dimension Report
Parameter by Item Report
Dimension Graph Report
Comment Report
Top Comment Report
Feedback Report
Key Driver Report
Score Card Report
Client Report
Top Clients Report
Survey count
Employee Engagement Report
Personal Employee Engagement Report (PEER®)
Employee Engagement Parameter Report
Parameter Report by Item or Demographic, Employee Engagement or Management Index

In one embodiment, the reporting system utilizes the organizational data to determine the access level for a user. For example, a user 105 with a organizational role of “team leader” is only able to see summary salary data (e.g. average salary) for respondents but a “manager” is able to access reports showing granular data relating specific salaries to specific responses.

In one embodiment, HRAS 115 includes a return on engagement calculator that provides an indication of the financial impact employee engagement can have on an organization. The return on engagement calculator receives engagement data associated with an organization's staff turnover rate, the organization's staff attendance and the organizations training cost. In various embodiments, the engagement data may be entered by a user 105, read from CDR 150 and/or received from external data source 161. The return on engagement calculator determines a return on engagement metric based at least partially upon the engagement data.

As disclosed briefly above, in an embodiment, HRAS 115 enables personalized employee engagement. Employers and managers are tasked with the full responsibility of evaluating and improving Employee Engagement within the workplace. The personalized employee engagement functionality helps correct this imbalance of accountability. Personalized employee engagement is an optional, and fully-confidential, process for users (e.g., an employee). For example, an employee may choose to invoke the personalized employee engagement process after the completion of an employee engagement survey. In one embodiment, the employee receives a report based on customized survey items, which can be administered as a stand-alone survey or as a supplement to a comprehensive or short-form survey.

In one embodiment, the employee indicates to HRAS 115 that the employee wishes to invoke the personalize employee engagement process. The employee is presented with a personalized employee engagement survey that addresses proven levels of employee engagement. In one embodiment, the personalized employee engagement survey comprises sixteen (16) items. The items may be associated with dimensions. For example, the items may be associated with one (or more) of four dimensions: Organizational Effectiveness, Recognition/Career Advancement, Supervision & Management, and Co-Worker Performance/Cooperation. HRAS 115 utilizes both measure and driver questions. “Measure items” address whether or not the employee is actually engaged, while “driver items” determine whether the employee's job conditions would allow for improved engagement. Often, when organizations fail to use a survey tool that incorporate both measures and drivers, organizations may lose the ability to accurately determine, while also understanding the reasons for, the engagement level of their workforce.

For example, the following items are considered “measures” of engagement, as they allow for an accurate determination of the employee's level of engagement (e.g., Actively Engaged, Ambivalent, or Actively Disengaged): “Employees here receive recognition for a job well done;” and “Employees here show an attitude of genuinely caring about the customer.” The following questions are “drivers” of Engagement: “All in all, I am satisfied with my job;” “My supervisor encourages my career growth;” and “Senior management of this organization is concerned about its employees.”

In an embodiment, SRE 147 analyzes responses in order to determine dynamic recommendations for the personalized employee engagement analysis. Upon completion of the personalized engagement survey, a report may be confidentially e-mailed to the user (e.g., employee). In an embodiment, a personalized employee engagement report not only reveals the employee's level of engagement (Actively Engaged, Ambivalent, or Actively Disengaged), but it also makes useful subject-specific suggestions on how the employee might enhance their Engagement. This best practice advice allows employees to actively address areas in which they have opportunity for improvement, without any (or minimal) intervention from management.

Exemplary features and benefits of the personalized employee engagement process are:

Employees discover their own engagement level based on their survey responses: (Actively Engaged, Ambivalent, or Actively Disengaged). Typical human resource and survey tools do not enable the opportunity to address individual engagement by providing personalized reports on the employee level. Typically engagement scores are accessed only by selected users and only reported on the organizational or work group level.

The system reveals areas where the employees' engagement level could be self-bolstered. Personalized employee engagement improves the employee engagement process by allowing employees to directly receive personalized best practice advice for improvement. For example, managers are alleviated the full responsibility for improving engagement, as employees themselves are provided with the necessary tools to create positive and lasting change.

The system analyzes responses and recommends proven action steps for individuals to improve their current engagement level.

The personalized employee engagement process supervisor communication best practices by encouraging managers to address employees and offer an opportunity to discuss report findings and work collaboratively on growing Engagement levels.

In one embodiment, HRAS 115 executes and/or enables the following process. 1) HRAS 115 sends a personalized link (e.g., a URL) to a personalized employee engagement user. 2) The user enters an email address to which a personalized employee engagement report will be sent. 3) SRE 147 determines personalized employee engagement survey items to present to the user. 4) SRE 147 processes the employee responses and dynamically produces recommendations based upon, for example, user responses, organizational data, organizational survey responses, statistical data, best practice data, organizational profile, user profile, and the like. 5) HRAS 115 may display results and recommendations on a web page and/or may send the employee a report (e.g. via email).

In an embodiment, SRE 147 calculates engagement levels based on, for example, specific criteria as described below. Answers are given based on a 5 Point Likert Scale: 1) Strongly Disagree; 2) Disagree; 3) Neutral; 4) Agree; 5) Strongly Agree. In an embodiment, Strongly Agree (Strongly Agree and Agree for the “I have thought of resigning in the last six months) is considered to be “Favorable Answers” while Disagree or Strongly Disagree are considered to be “Unfavorable Answers.”

In an embodiment, SRE 147 executes an algorithm to calculate engagement level. For example, the algorithm may be based on 15 items and require that a minimum of 12 items be answered.

Engaged Engagement Score %=(Number of Percent Favorable Answers/Total Number Items Answered)

Disengaged Engagement Score %=(Number of Percent Unfavorable Answers/Total Number of Items Answered)

In an embodiment, a personalized employee engagement survey with less than 12 items answered will not be calculated and the system returns to the survey page with an error message.

Engagement Level falls into categories as described below:

Actively Engaged: IF Percent Favorable Answers>=33% AND Percent Unfavorable Answers<=20%;

Neither Engaged nor Disengaged: IF (Percent Favorable Answers>=21% AND<=32%) AND (Percent Unfavorable Answers>=21% AND<=32%); and,

Actively Disengaged: IF (Percent Favorable Answers>=0% AND<=20%) AND (Percent Unfavorable Answers>=33% AND<=100%).

In an embodiment, SRE 147 determines the top 3 lowest scoring items based weighing of question significance. The top 3 lowest scoring items are then selected from the questionnaires answers. Each question is associated with corresponding recommendations to help enhance engagement levels.

In an embodiment, HRAS 115 may include one or more of the following components to enable the personalized employee engagement functions:

1) Upload File Proofer—The file proofer checks against complex validations to identify where a file is incorrect and specific reasons why the errors occur.

2) Upload File Processer—The file processor uploads the actual data, computes all scores, enters data processed into the database, and sends corresponding users their unique personalized employee engagement® Report. In an embodiment, the Upload File Processor is integrated into SRE 147.

3) Email Verification and Error Report—The Email Verification system and Error Report system delivers a report to system administrators that notifies which emails from the large upload batch could not be sent, or were undeliverable.

4) Personalized Employee Engagement Resend Module—This module allows SRE 147 and/or system administrators to easily and efficiently find ‘incorrect’ emails and replace the entry in the database to the ‘correct’ email, allowing for a resend to the customer in an easy to use page.

5) Personalized Employee Engagement Link Creator—This module enables the system to easily and properly create individual links for a personalized employee engagement processes.

6) Personalized Employee Engagement Tracking—This module allows users to track whether or not a client/contact has taken personalized employee engagement with the unique link sent to the client generated by the link creator.

While the steps outlined above represent specific embodiments of the invention, practitioners will appreciate that there are any number of computing algorithms and user interfaces that may be applied to create similar results. The steps are presented for the sake of explanation only and are not intended to limit the scope of the invention in any way.

Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of any or all the claims of the invention. It should be understood that the detailed description and specific examples, indicating exemplary embodiments of the invention, are given for purposes of illustration only and not as limitations. Many changes and modifications within the scope of the instant invention may be made without departing from the spirit thereof, and the invention includes all such modifications. Corresponding structures, materials, acts, and equivalents of all elements in the claims below are intended to include any structure, material, or acts for performing the functions in combination with other claim elements as specifically claimed.

The scope of the invention should be determined by the appended claims and their legal equivalents, rather than by the examples given above. Reference to an element in the singular is not intended to mean “one and only one” unless explicitly so stated, but rather “one or more.” Moreover, when a phrase similar to “at least one of A, B, or C” or “at least one of A, B, and C” is used in the claims or the specification, the phrase is intended to mean any of the following: (1) at least one of A; (2) at least one of B; (3) at least one of C; (4) at least one of A and at least one of B; (5) at least one of B and at least one of C; (6) at least one of A and at least one of C; or (7) at least one of A, at least one of B, and at least one of C.

1. A method, comprising:
receiving, at an engagement score computer, a first request to perform a personalized employee engagement;
creating, by the computer and based upon the request, a personalized link;
sending, by the computer, the personalized link to a user;
receiving, by the computer, a second request to take a personalized employee engagement survey, wherein the request is received via the user accessing the link;
presenting, by the computer and to the user, personalized engagement survey questions;
receiving, by the computer, responses to the personalized engagement survey questions;
determining, by the computer and based at least partially on the responses, a level of engagement;
determining, by the computer and based at least partially on the responses and the level of engagement, a recommendation on how the user may increase the engagement score; and
communicating, by the computer, to the user at least one of the engagement score and the recommendation.

2. The method of claim 1, wherein the personalized employee engagement questions are each associated with at least one of four dimensions.

3. The method of claim 2, wherein the four dimensions comprise: organizational effectiveness; recognition and advancement; supervision and management; and co-worker performance and cooperation.

4. The method of claim 1, wherein the personalized employee engagement questions are categorized as a measure items or a driver items.

5. The method of claim 4, wherein the measure items address whether the user is actually engaged, and wherein the driver items address whether the user's job conditions would allow for improved engagement.

6. The method of claim 1, further comprising calculating an engagement score based upon the responses.

7. The method of claim 6, wherein the responses are based on a five point scale;

8. The method of claim 6, wherein the responses comprise: strongly disagree; disagree;
neutral; agree; and strongly agree.

9. The method of claim 8, wherein responses agree and strongly agree are associated with favorable responses and wherein responses disagree and strongly disagree are associated with unfavorable responses.

10. The method of claim 9, further comprising calculating an engagement score as favorable response divided by a number of total responses; and calculating a disengagement score as the number of unfavorable answers divided by the number of total responses.

11. The method of claim 10, wherein, in response to the number of total responses being less than 12, at least one of generating an error message and prompting the user to respond to more personalized employee engagement survey questions.

12. The method of claim 10, wherein the level of engagement comprises at least one of:
actively engaged; ambivalent; and actively disengaged.

13. The method of claim 12, further comprising:
determining the level of engagement as actively engaged in response to the engagement score being greater than or equal to 0.333 and the disengagement score being less than or equal to 0.20;
determining the level of engagement as ambivalent in response to the engagement score being greater than 0.20 and less than 0.33 and the disengagement score being greater than 0.20 and less than 0.33; and
determining the level of engagement as ambivalent in response to the engagement score being greater than 0 and less than 0.20 and the disengagement score being greater than 0.33 and less than 1.0.

14. The method of claim 1, wherein the communicating comprises generating a personalized employee engagement report.

15. The method of claim 14, wherein the communicating further comprises sending the personalized employee engagement report to the user via email.

16. The method of claim 1, wherein the receiving the first request comprises receiving the first request in response to the user completing an employee opinion survey.

17. The method of claim 16, further comprising administering the employee opinion survey by:
identifying, by the computer, possible survey items;
transforming, by the computer, survey configuration data and the possible survey items into a survey, wherein the survey comprises final survey items, final survey respondents and a survey format, wherein the final survey items are a subset of the possible survey items, and wherein the survey configuration data comprises an identification of requested survey respondents, wherein the identification is based at least partially on organizational data for an organization;
receiving, by the computer, survey responses from a subset of survey respondents;
analyzing, by the computer, survey responses based upon at least one of the organizational data or predefined rules, to create survey results; and
enabling, by the computer, configuration of an action plan based upon at least one survey result.

18. The method of claim 17, wherein the transforming further comprises associating the final survey items with dimensions comprised of at least one of a standard dimension stored in a database or a custom dimension received in the survey configuration data and wherein the analyzing the survey results comprises at least one of performing statistical calculations, comparing the survey results with historical results, combining the survey results with historical results, determining a trend, or comparing the results to a threshold.

19. A non-transitory computer-readable medium having computer-executable instructions stored thereon that, if executed by an engagement score computer for assessing personalized employee engagement, cause the computer to perform operations comprising:
receiving, at the computer, a first request to perform a personalized employee engagement;
creating, by the computer and based upon the request, a personalized link;
sending, by the computer, the personalized link to a user;
receiving, by the computer, a second request to take a personalized employee engagement survey, wherein the request is received via the user accessing the link;
presenting, by the computer and to the user, personalized engagement survey questions;
receiving, by the computer, responses to the personalized engagement survey questions;
determining, by the computer and based at least partially on the responses, a level of engagement;
determining, by the computer and based at least partially on the responses and the level of engagement, a recommendation on how the user may increase the engagement score; and
communicating, by the computer, to the user at least one of the engagement score and the recommendation.

20. A system for assessing a personalized employee engagement comprising:
a network interface communicating with a memory;
the memory communicating with a processor; and
the processor, when executing a computer program, is configured to:
receive a first request to perform a personalized employee engagement;
create, based upon the request, a personalized link;
send the personalized link to a user;
receive a second request to take a personalized employee engagement survey, wherein the request is received via the user accessing the link;
present, to the user, personalized engagement survey questions;
receive responses to the personalized engagement survey questions;
determine, based at least partially on the responses, a level of engagement;
determine, based at least partially on the responses and the level of engagement, a recommendation on how the user may increase the engagement score; and
communicate to the user at least one of the engagement score and the recommendation.
